(19) United States
(12) Patent Application Publication
(10) Pub. No.: US 2026/0099696 A1
(43) Pub. Date: Apr. 9, 2026

(54) ELECTRONIC APPARATUS FOR PROVIDING RECOMMENDATION INFORMATION AND OPERATING METHOD THEREOF

(71) Applicant: UIF (University Industry Foundation), Yonsei University, Seoul (KR)

(72) Inventors: Noseong Park, Seoul (KR); Yehjin Shin, Seoul (KR); Jeongwhan Choi, Seoul (KR); Hyowon Wi, Seoul (KR)

(21) Appl. No.: 18/931,310

(22) Filed: Oct. 30, 2024

(30) Foreign Application Priority Data
Oct. 8, 2024 (KR) 10-2024-0136316

(51) Int. Cl. G06N 3/045; G06N 3/0499

(52) U.S. Cl. CPC G06N 3/045; G06N 3/0499

(57) ABSTRACT

The present disclosure relates to an electronic apparatus for providing recommendation information and an operating method thereof. A method of providing recommendation information, the method being performed by an electronic apparatus, includes acquiring a data set including a plurality of data having a sequential pattern, deriving recommendation information corresponding to the data set using a trained artificial intelligence model, and providing the recommendation information to an external apparatus, wherein the artificial intelligence model is constructed to include a first layer that performs embedding on the data set, a (2-1)-th layer that performs self-attention based on a result of the embedding by the first layer, and a (2-2)-th layer that performs data processing to inject an inductive bias based on the result of the embedding by the first layer.

### CROSS-REFERENCE TO RELATED APPLICATIONS

This application claims priority under 35 U.S.C. § 119 to Korean Patent Application No. 10-2024-0136316 filed on Oct. 8, 2024, in the Korean Intellectual Property Office, the disclosures of which are incorporated by reference herein in their entireties.

### BACKGROUND

Embodiments of the present disclosure described herein relate to intelligent information technology, and more particularly, relate to an electronic apparatus for providing recommendation information adaptively derived based on user information and an operating method thereof.

A recommendation system refers to a system that recommends content (e.g., products, films, images, news, etc.) that may be of interest to a user. The recommendation system may provide content that may be of interest to a user based on the user's preferences and past behaviors using machine learning. The basic algorithms for implementing a recommendation system may include content-based filtering, which recommends similar content that corresponds to a user's past history based on the basic information of content, and collaborative filtering, which recommends content to a user by inferring ratings for unrated items based on a latent factor matrix between the user and items. With the recent advancements in big data and artificial intelligence, recommendation systems are evolving in the direction of hyper-personalization using machine learning, rather than simply recommending content.

As research on recommendation systems has been actively conducted, the concept of a sequential recommendation system that recommends content by considering the context of a user's behavior has been proposed. Artificial intelligence models such as convolutional neural networks (CNNs) and recurrent neural networks (RNNs) were used in the early sequential recommendation systems, but recently, transformer models, which complement their shortcomings, have frequently been used in sequential recommendation systems. However, the mechanism of a self-attention-based transformer model suffers from a lack of inductive bias, which refers to the assumptions to predict outputs in response to inputs that the learner has not encountered in a training algorithm, and from over-smoothing, which causes excessive uniformity as a network integrates information. Therefore, solutions to address these issues are needed.

In this regard, Korean Patent Publication No. 10-2474747B1 and Korean Patent Publication No. 10-2517728B1 may be referred to.

### SUMMARY

Embodiments of the present disclosure provide an electronic apparatus for providing recommendation information adaptively derived based on user information, and an operating method thereof.

Embodiments of the present disclosure provide an electronic apparatus for providing recommendation information using a model injected with an inductive bias based on a sequential pattern and an operating method thereof.

Embodiments of the present disclosure provide an electronic apparatus for providing recommendation information by integrating information corresponding to a low frequency band and information corresponding to a high frequency band and an operating method thereof.

The problems to be solved by the present disclosure are not limited to the above-described problems, and other problems not described herein to be solved by the present disclosure can be clearly understood by those skilled in the art from the following description.

According to an embodiment, a method for providing recommendation information, the method being performed by an electronic apparatus, includes acquiring a data set including a plurality of data having a sequential pattern, deriving recommendation information corresponding to the data set using a trained artificial intelligence model, and providing the recommendation information to an external apparatus, wherein the artificial intelligence model is constructed to include a first layer that performs embedding on the data set, a (2-1)-th layer that performs self-attention based on a result of the embedding by the first layer, and a (2-2)-th layer that performs data processing to inject an inductive bias based on the result of the embedding by the first layer.

In an embodiment, the artificial intelligence model may include a (3-1)-th layer that performs residual connection and normalization of a first result value derived from the (2-1)-th layer, a (3-2)-th layer that performs residual connection and normalization of a second result value derived from the (2-2)-th layer, a fourth layer that performs feed forward based on a third result value derived from the (3-1)-th layer and a fourth result value derived from the (3-2)-th layer, a fifth layer that performs residual connection and normalization based on a fifth result value derived from the fourth layer, and a sixth layer that performs a prediction for the recommendation information based on a sixth result value derived from the fifth layer.

In an embodiment, the fourth layer may perform the feed forward with a first weight assigned to the third result value and a second weight assigned to the fourth result value, and the first weight and the second weight may have a correlation.

In an embodiment, the (2-2)-th layer may perform a Fast Fourier Transform (FFT) on the result of the embedding by the first layer, separating a signal derived by the Fast Fourier Transform into a first signal including a low frequency band equal to or less than a preset threshold frequency and a second signal including a high frequency band greater than the threshold frequency, perform an inverse transform on each of the first signal and the second signal, and derive the second result value based on an inversely-transformed first signal and an inversely-transformed second signal.

In an embodiment, the second result value may be derived by applying a third weight derived from training of the artificial intelligence model to the inversely-transformed second signal.

In an embodiment, the (2-2)-th layer may perform the data processing based on a Discrete Fourier Transform (DFT) on the result of the embedding by the first layer.

In an embodiment, the data set may include the plurality of data corresponding to one of a user's product purchase history, a user's program viewing history, and a user's search history.

In an embodiment, the method may further include performing preprocessing, the preprocessing including at least one of a first operation of converting a data format for each of the plurality of data and a second operation of extracting at least a portion of the plurality of data.

According to an embodiment, an electronic apparatus for providing recommendation information includes a transceiver, a memory that stores instructions, and a processor, wherein the processor, connected to the transceiver and the memory, acquires a data set including a plurality of data having a sequential pattern, derives recommendation information corresponding to the data set using a trained artificial intelligence model, and provides the recommendation information to an external apparatus, and the artificial intelligence model includes a first layer configured to perform embedding on the data set, a (2-1)-th layer that performs self-attention based on a result of the embedding by the first layer, and a (2-2)-th layer that performs data processing to inject an inductive bias based on the result of the embedding by the first layer.

According to an embodiment, a computer program stored on a computer-readable storage medium for executing a method of providing recommendation information in conjunction with hardware, wherein the method of providing the recommendation information includes acquiring a data set including a plurality of data having a sequential pattern, deriving recommendation information corresponding to the data set using a trained artificial intelligence model, and providing the recommendation information to an external apparatus, and the artificial intelligence model includes a first layer that performs embedding on the data set, a (2-1)-th layer that performs self-attention based on a result of the embedding by the first layer, and a (2-2)-th layer that performs data processing to inject an inductive bias based on the result of the embedding by the first layer.

The present disclosure provides recommendation information using a model injected with an inductive bias based on a sequential pattern, thereby addressing an issue of derivation of incomplete output information in response to unlearned situations in existing models.

The present disclosure provides recommendation information by integrating information corresponding to a low-frequency band and information corresponding to a high-frequency band, thereby addressing over-smoothing issues that may occur in conventional AI models and improving the accuracy of output information.

The effects according to the present disclosure are not limited to the above-described effects, and other effects according to the present disclosure not described herein can be clearly understood by those skilled in the art from the following description.

### BRIEF DESCRIPTION OF THE FIGURES

FIG. 1 is a block diagram illustrating a recommendation information providing system according to an embodiment of the present disclosure.

FIG. 2 is a block diagram illustrating an electronic apparatus that provides recommendation information according to an embodiment of the present disclosure.

FIG. 3 is a diagram for describing the structure of an architecture constructed for an electronic apparatus according to an embodiment of the present disclosure.

FIG. 4 is a diagram for describing an operation performed by a portion of an architecture constructed for an electronic apparatus according to an embodiment of the present disclosure.

FIG. 5 is a flowchart for describing an operating method of an electronic apparatus according to an embodiment of the present disclosure.

FIG. 6 is a table showing performance of an electronic apparatus according to an embodiment of the present disclosure.

FIG. 7 is a block diagram illustrating an electronic apparatus according to an embodiment of the present disclosure.

### DETAILED DESCRIPTION

Hereinafter, example embodiments according to the present disclosure will be described in detail with reference to the accompanying drawings. However, the present disclosure is not limited or restricted by these example embodiments. Unless otherwise defined, the terms used herein (including technical and scientific terms) will be used with meanings commonly understood by those skilled in the art to which the present disclosure belongs, but may vary depending on the intention of a person skilled in the art, precedents, the emergence of new technologies, or the like.

Further, the terms defined in a generally used dictionary are not ideally or excessively interpreted unless explicitly specially defined. In a specific case, some terms are randomly selected by the applicant, and in this case, the meaning of the terms will be described in detail in the corresponding description of the disclosure. Accordingly, terms used in the present disclosure should be defined based on their substantial meanings and contents over the present disclosure, not the simple names of the terms.

Throughout the specification, unless explicitly described to the contrary, the word “comprise” and variations such as “comprises” or “comprising” will be understood to imply the inclusion of stated elements but not the exclusion of any other elements. In addition, the singular expressions include plural expressions unless the context clearly dictates otherwise. Further, the expression ‘at least one of a, b, and c’ as described throughout this specification may encompass ‘a alone,’ ‘b alone,’ ‘c alone,’ ‘a and b,’ ‘a and c,’ ‘b and c,’ or ‘a, b, and c together.

Meanwhile, terms such as “first and/or second” used in this specification may be used to describe various components, but they are only used for the purpose of distinguishing one component from another component, and are not intended to be limited to the components referred to by the terms. For example, a first component may be named as a second component, and vice versa, without departing from the spirit or scope of the present disclosure.

In addition, the terms “ . . . unit”, “ . . . er”, “module”, “device”, or the like described in the specification mean a unit that processes at least one function or operation, which can be implemented by hardware or software or a combination thereof. Further, embodiments of the present disclosure may be represented with functional blocks and various processing steps. These functional blocks can be implemented by various numbers of hardware and/or software configurations for executing specific functions. For example, the embodiments of the present disclosure may adopt direct circuit configurations, such as memory, processing, logic, and look-up table, for executing various functions under control of one or more microprocessors or by other control devices.

In the embodiments of the present disclosure, artificial intelligence-related functions may be implemented through at least one processor and at least one memory. In this case, the processor may be any of a general-purpose processor such as a Central Processing Unit (CPU), an Application Processor (AP), or a Digital Signal Processor (DSP), a graphics processor such as a Graphics Processing Unit (GPU) or a Vision Processing Unit (VPU), or an AI-specific processor such as an Neural Network Processing Unit (NPU). The processor may process input data according to predefined operational rules or AI models stored in the memory. Meanwhile, if the processor is an AI-specific processor, the AI-specific processor may be designed with a hardware structure specialized for processing of a specific AI model. In some embodiments of the present disclosure, artificial intelligence-related functions may be implemented through a plurality of processors.

In an embodiment of the present disclosure, the predefined operational rules or artificial intelligence models may be configured to perform machine learning. Here, being configured to perform machine learning may mean that the predefined operational rules or AI models are configured to achieve desired characteristics or objectives by being trained using a plurality of training data sets based on learning algorithms. Such learning may be performed on an artificial intelligence-based device itself, according to the present disclosure, or via separate servers and/or systems.

The artificial intelligence model may be implemented with a neural network (or artificial neural network) and may operate based on statistical learning algorithms that mimic the biological neural system in machine learning and cognitive science. A neural network generally refers to a model having problem-solving ability in such a way that artificial neurons (nodes) constituting a network with synaptic bonding change the strength of synaptic bonding through learning. The neural network may consist of a plurality of neural network layers, for example, including an input layer, hidden layers, and an output layer. Each of the plurality of neural network layers may include at least one node and at least one weight, and perform neural network operations through operations between weights and the results of operations in the previous layer. At least one weight in the plurality of neural network layers may be optimized as a result of training the artificial intelligence model. For example, at least one weight may be updated to reduce or minimize the loss or cost value obtained during the learning process in the artificial intelligence model. A neural network may infer a desired result from a certain input.

The training method for the artificial intelligence model may be classified by the type of learning, such as supervised learning, in which both input and output data are provided as training data, and the correct answer (output data) corresponding to a question (input data) is determined; unsupervised learning, in which only input data is provided without output data, and there is no determined correct answer for a question; and reinforcement learning, in which a reward is given for each action taken in the current state, with learning proceeding in a way that maximizes these rewards. Alternatively, classification may be based on the structure or architecture of the learning model.

Hereinafter, various embodiments of the present disclosure will be described in detail with reference to the accompanying drawings. In describing the embodiments, descriptions of technical contents that are well known in the technical field to which the present disclosure pertains and are not directly related to the present disclosure will be omitted. This is to more clearly convey the gist of the present disclosure by omitting unnecessary description. For the same reason, in the accompanying drawings, some elements are enlarged, omitted, or depicted schematically. Furthermore, the size of each element does not accurately reflect its real size. In this specification, the same reference numerals may refer to the same or corresponding components throughout.

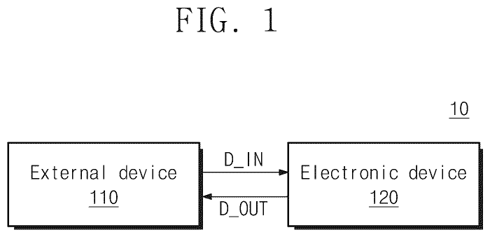

FIG. 1 is a block diagram illustrating a recommendation information providing system 10 according to an embodiment of the present disclosure.

Referring to FIG. 1, the recommendation information providing system 10 according to an embodiment of the present disclosure may include an external apparatus 110 and an electronic apparatus 120. In the recommendation information providing system 10 according to an embodiment of the present disclosure, the external apparatus 110 and the electronic apparatus 120 may communicate with each other via a network or an electrical connection structure physically implemented, and provide information.

According to an embodiment of the present disclosure, the network may include at least one of a Personal Area Network (PAN), a Local Area Network (LAN), a Campus Area Network (CAN), a Metropolitan Area Network (MAN), a Wide Area Network (WAN), a Broad Band Network (BBN), and the Internet. In addition, the network may include at least one of network topologies including a bus network, a star network, a ring network, a mesh network, a star-bus network, a tree network, a hierarchical network or the like. In an embodiment of the present disclosure, a communication method performed is not limited to the types of the above-described networks, and may include not only a communication method utilizing a communication network that the network may include, but also short-range wireless communication between apparatuses.

In an embodiment of the present disclosure, each of the external apparatus 110 and the electronic apparatus 120 may include a transceiver, a memory, and a processor. In addition, each of the external apparatus 110 and the electronic apparatus 120 may refer to a unit that processes at least one function or operation, which may be implemented by hardware or software, or a combination of hardware and software. In an embodiment, each of the external apparatus 110 and the electronic apparatus 120 may include a plurality of computer systems or computer software which are implemented with network servers. For example, each of the external apparatus 110 and the electronic apparatus 120 may refer to a computer system and computer software which is connected to a sub-device capable of communicating with another network server via a computer network such as an intranet or the Internet to receive a task execution request, execute a task for the request, and provide a result of the execution.

Although the external apparatus 110 and the electronic apparatus 120 are described in this specification as physically separated components, this is merely an embodiment according to the present disclosure, and according to another embodiment of the present disclosure, the external apparatus 110 and the electronic apparatus 120 may have logically separated components, and in this case, may be implemented as separated functions in a single server. In addition, each of the external apparatus 110 and the electronic apparatus 120 may be understood as a broad concept that includes a series of application programs capable of running on a network server and various built-in databases. For example, each of the external apparatus 110 and the electronic apparatus 120 may be implemented using a network server program provided in various ways according to an operating system such as DOS, Windows, Linux, Unix, or MacOS.

In an embodiment according to the present disclosure, the external apparatus 110 may be implemented as a computer or portable terminal capable of accessing a server or other terminal via a network. For example, the computer may include a notebook, desktop, laptop, etc. equipped with a WEB Browser, and the portable terminal may include, for example, a wireless communication device that ensures portability and mobility, such as a communication-based terminal such as IMT (International Mobile Telecommunication), CDMA (Code Division Multiple Access), W-CDMA (W-Code Division Multiple Access), LTE (Long Term Evolution), and all kinds of handheld-based wireless communication devices such as smartphones, tablet PCs, etc. In an embodiment according to the present disclosure, the external apparatus 110 may provide input information D_IN to the electronic apparatus 120. In an embodiment, the input information D_IN may include information related to content used by a user, such as products, movies, images, or news.

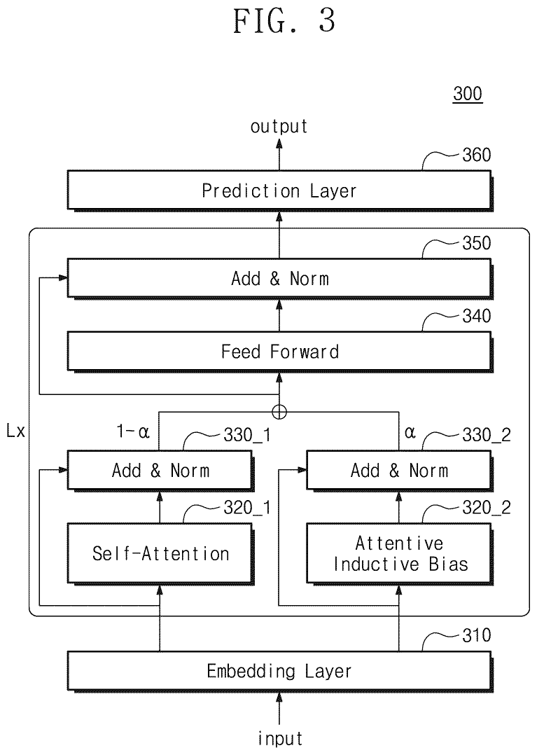

In an embodiment according to the present disclosure, the electronic apparatus 120 may derive recommendation information based on the input information and provide output information D_OUT including the derived recommendation information to the external apparatus 110. The recommendation information may be information extracted based on a plurality of data having a sequential pattern, which may indicate information about content that is expected to be of interest to the user. In an embodiment, the electronic apparatus 120 may include an artificial intelligence AI model for deriving recommendation information, and a structure of the AI model according to an embodiment of the present disclosure will be described in detail with reference to FIG. 3 below. Meanwhile, in an embodiment according to the present disclosure, input for the AI model may be a data set identified based on the input information D_IN for the electronic apparatus 120, and the data set may include a plurality of data related to content used by the user. In an embodiment, the data set may be configured to include the plurality of data having a sequential pattern.

The recommendation information providing system 10 according to an embodiment of the present disclosure may provide recommendation information adaptively derived based on user information. The recommendation information providing system 10 according to an embodiment of the present disclosure may provide recommendation information through an AI model injected with an inductive bias based on the sequential pattern, thereby addressing issues of incomplete output information being derived in response to a situation that has not been learned in an existing artificial intelligence model. In addition, the recommendation information providing system 10 according to an embodiment of the present disclosure may provide recommendation information by integrating information corresponding to a low-frequency band and information corresponding to a high-frequency band, which may address over-smoothing issues that may occur in conventional AI models and improve the accuracy of output information.

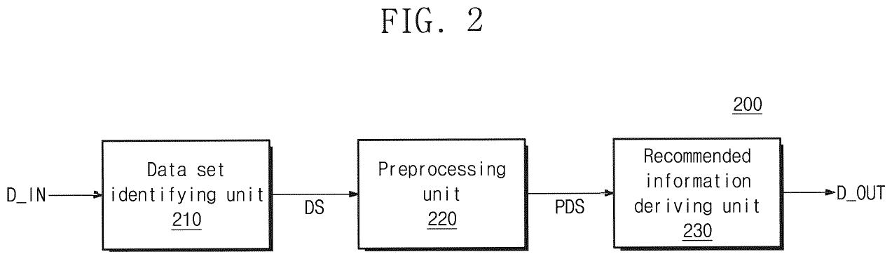

FIG. 2 is a block diagram illustrating an electronic apparatus 200 that provides recommendation information according to an embodiment of the present disclosure.

The electronic apparatus 200 shown in FIG. 2 may correspond to the electronic apparatus 120 described in FIG. 1. Referring to FIG. 2, the electronic apparatus 200 according to an embodiment of the present disclosure may include a data set identifying unit 210, a preprocessing unit 220, and a recommendation information deriving unit 230.

According to an embodiment of the present disclosure, the data set identifying unit 210 may configure a data set DS that includes a plurality of data having a sequential pattern based on the input information D_IN provided for the electronic apparatus 200. For example, the plurality of data having a sequential pattern may include data related to a user's purchase history, data related to the user's viewing history, or data related to the user's search history on the Internet. In an embodiment, the plurality of data having a sequential pattern may be acquired once from the external apparatus 110 (see FIG. 1) or may be acquired in real-time from the external apparatus 110 in response to the user's actions, stored in the electronic apparatus 200, and extracted from cumulative data. The data set identifying unit 210 may provide the data set DS, which includes the plurality of data having a sequential pattern, to the preprocessing unit 220.

According to an embodiment of the present disclosure, the preprocessing unit 220 may perform preprocessing on the data set DS. The preprocessing performed by the preprocessing unit 220 may involve at least one of operation of converting the data set DS into a data format to be input to the recommendation information deriving unit 230 and operation of extracting at least a portion of the data set DS. In some embodiments, the preprocessing of the data set DS may include at least one of tokenization, token indexing, token padding, and positional encoding for each of the plurality of data included in the data set DS. The data set PDS preprocessed by the preprocessing unit 220 may be provided to the recommendation information deriving unit 230.

According to an embodiment of the present disclosure, the recommendation information deriving unit 230 may derive recommendation information for the user based on the preprocessed data set PDS. The recommendation information deriving unit 230 may include an AI model for deriving recommendation information, and in some embodiments, the AI model constructed for the recommendation information deriving unit 230 may utilize layers constructed for a transformer model. The AI model constructed for the recommendation information deriving unit 230 may be trained based on a data set corresponding to the attributes of data input into the electronic apparatus 120, and the structure of the AI model will be described in detail with reference to FIG. 3 below.

Although it is illustrated in FIG. 2 that the data set identifying unit 210, the preprocessing unit 220, and the recommendation information deriving unit 230 are physically separated components, this is only for ease of understanding of the operation of the electronic apparatus 200 according to the present disclosure and does not limit the configuration of the electronic apparatus 200 according to the present disclosure. The data set identifying unit 210, the preprocessing unit 220, and the recommendation information deriving unit 230 illustrated in FIG. 2 are classified according to functions to be performed, and may be understood as logically separated components.

FIG. 3 is a diagram for describing the structure 300 of architecture constructed for the electronic apparatus 120, (see FIG. 1) according to an embodiment of the present disclosure.

An artificial intelligence model having the structure 300 of the architecture illustrated in FIG. 3 may be constructed for the recommendation information deriving unit 230 of FIG. 2 described above, and in some embodiments, may be constructed across the preprocessing unit 220 and the recommendation information deriving unit 230 of FIG. 2 described above.

Referring to FIG. 3, data input to the artificial intelligence model according to an embodiment of the present disclosure may be provided to a first layer 310. The first layer 310 may refer to a layer for generating an embedding, which is a vector representation of the input data. When a data set including data tokenized by the preprocessing unit 220 is input to the artificial intelligence model, the first layer 310 may map a relevant token to a high-dimensional real number vector. The data resulting from the embedding may be provided to each of a (2-1)-th layer 320_1 for performing self-attention and a (2-2)-th layer 320_2 for injecting inductive bias.

In an embodiment, the (2-1)-th layer 320_1 may model how each of elements of an input data sequence interacts with other elements. Specifically, the (2-1)-th layer 320_1 may generate vectors respectively corresponding to a query, a key, and a value based on the input data sequence, and measure a similarity between a query vector and a key vector to calculate an attention score. The (2-1)-th layer 320_1 may derive a relative importance between the query and the key by applying the Softmax function to convert the attention score into a probability distribution. The (2-1)-th layer 320_1 may perform an operation on the value vector based on the derived importance and provide a derived result value to a (3-1)-th layer 330_1.

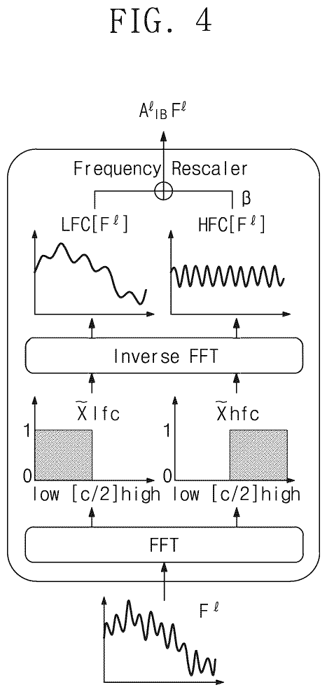

Meanwhile, in the embodiment, the (2-2)-th layer 320_2 may perform data processing to improve the accuracy of a predicted result for data that has not been learned based on the input data sequence. Specifically, the (2-2)-th layer 320_2 may perform a Discrete Fourier transform (DFT) on the input data sequence, separate a signal derived through the Discrete Fourier transform into a low-frequency band and a high-frequency band, and derive a result value through an operation on the separated signal. A data processing method in the (2-2)-th layer 320_2 according to an embodiment of the present disclosure will be described in detail through FIG. 4 to be described below. The result value derived from the (2-2)-th layer 320_2 may be provided to a (3-2)-th layer 330_2.

In an embodiment, each of the (3-1)-th layer 330_1 and the (3-2)-th layer 330_2 may perform residual connection and normalization on an input value. Specifically, the (3-1)-th layer 330_1 may perform an operation on a data sequence input to the (2-1)-th layer 320_1 and a result value obtained by performing self-attention on the data sequence, and the (3-2)-th layer 330_2 may perform an operation on a data sequence input to the (2-2)-th layer 320_2 and a result value obtained by performing data processing based on Fourier transform on the data sequence. The result values of the operations, which are respectively derived from the (3-1)-th layer 330_1 and the (3-2)-th layer 330_2 may be weighted and added together, a result value resulting therefrom may be provided to a fourth layer 340 for feed forward, and a result value derived from the fourth layer 340 may be provided to a fifth layer 350 for performing residual connection and normalization. In an embodiment, a result value derived from the fifth layer 350 may be provided to the (2-1)-th layer 320_1 and the (2-2)-th layer 320_2 for regression, and a result value derived by repeating the above-described process “1” times (I is a natural number greater than or equal to 1) may be provided to a sixth layer 360 to derive a predicted value, and the sixth layer 360 may derive recommendation information as a final output value.

FIG. 4 is a diagram for describing an operation performed by a portion of an architecture constructed for the electronic apparatus 120 (see FIG. 1) according to an embodiment of the present disclosure.

More specifically, FIG. 4 is a diagram for describing a data processing operation performed in the (2-2)-th layer 320_2 (see FIG. 3) described through FIG. 3, which illustrates an embodiment in which a fast Fourier transform (FFT) is performed on an input data sequence for faster operation. According to an embodiment of the present disclosure, the electronic apparatus 120 may separate a signal, which is derived through Fast Fourier transform for a data sequence input to an artificial intelligence model, into a first signal including a low-frequency band and a second signal including a high-frequency band. In an embodiment, the electronic apparatus 120 may extract a signal corresponding to a band equal to or less than a preset threshold frequency as a first signal, and extract a signal corresponding to a band greater than the threshold frequency as a second signal.

The electronic apparatus 120 may perform an inverse fast Fourier transform (inverse FFT) on each of the first signal and the second signal, and perform a sum operation on the first signal and the second signal on which the inverse transform has been performed. According to an embodiment, when the sum operation is performed, a weight may be assigned to the second signal on which the inverse transform has been performed, and the weight assigned to the second signal on which the inverse transform has been performed may be determined by learning of the artificial intelligence model. Specifically, an operation formula related to a result value derived as a result of performing the sum operation may be expressed as Equation 1 below.

$${A}_{IB}^{ℓ} {X}^{ℓ} = LFC [ {X}^{ℓ} ] + β HFC [ {X}^{ℓ} ] \qquad [ Equation 1 ]$$

[symbol] may denote a data sequence input to the (2-2)-th layer 320_2 (see FIG. 3), and in the case of [symbol] =0, X⁰ may denote an embedding result corresponding to the preprocessed data set PDS (see FIG. 2) provided to the recommendation information deriving unit 230. Meanwhile, β may denote a weight assigned to the second signal on which the inverse transform has been performed. In an embodiment, the first signal including a low-frequency band may be used to reflect the overall pattern of input information, and the second signal including a high-frequency band may be used to reflect deviations from the pattern of the input information. According to an embodiment of the present disclosure, the electronic apparatus 120 may perform an operation by assigning weights to the second signal including a high-frequency band to reflect a user's non-specific pattern, thereby improving the performance of providing recommendation information to the user.

Meanwhile, the calculation formula related to the process of applying weights to and adding up the operation result values derived from the (3-1)-th layer 330_1 (see FIG. 3) and the (3-2)-th layer 330_2 (see FIG. 3) described via FIG. 3 may be expressed as the following Equation 2.

$${S}^{ℓ} = α {A}_{IB}^{ℓ} {X}^{ℓ} + ( 1 - α ) {A}^{ℓ} {X}^{ℓ} \qquad [ Equation 2 ]$$

In Equation 2, [symbol] may refer to a data sequence input to each of the (2-1)-th layer 320_1 and the (2-2)-th layer 320_2, and in the case of [symbol] =0 as in Equation 1, X⁰ may denote an embedding result corresponding to the preprocessed data set PDS provided to the recommendation information deriving unit 230. In Equation 2, [symbol] may denote a self-attention matrix reflecting the operation process applied by the (2-1)-th layer 320_1 in the [symbol] -th process.

Meanwhile, a weight may be assigned to each of the result value ( [symbol] ) derived from the (3-1)-th layer 330_1 and the result value ( [symbol] ) derived from the (3-2)-th layer 330_2. The weights respectively assigned to result values may have a mutual relationship, and when a weight of α is assigned to the result value ( [symbol] ) derived from the (3-2)-th layer 330_2, a weight of (1−α) may be assigned to the result value ( [symbol] ) derived from the (3-1)-th layer 330_1. In an embodiment, α is a value preset for the electronic apparatus 120, may be a value within the range of 0 to 1, and may be set to a value of, for example, 0.1, 0.3, 0.5, 0.7, or 0.9. The result value ( [symbol] ) derived from Equation 2 may be provided to the fourth layer 340 and the fifth layer 350.

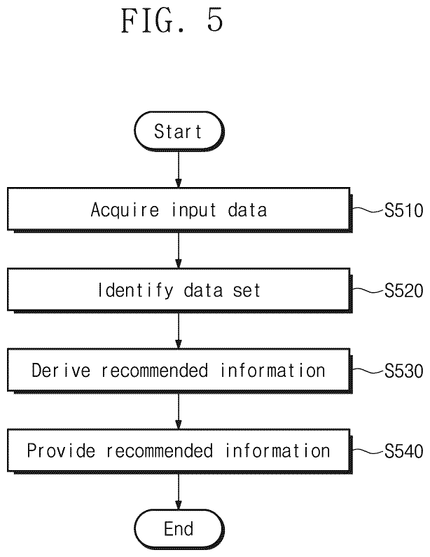

FIG. 5 is a flowchart for describing an operation method of the electronic apparatus 120 (see FIG. 1) according to an embodiment of the present disclosure.

In step S510, the electronic apparatus 120 according to an embodiment of the present disclosure may obtain input information from the external apparatus 110 (see FIG. 1). In an embodiment, the input information may include information related to content used by a user, such as products, movies, images, or news.

In step S520, the electronic apparatus 120 according to an embodiment of the present disclosure may identify a data set including a plurality of data related to the content used by the user based on the input information. The plurality of data included in the data set may have a sequential pattern.

In step S530, the electronic apparatus 120 according to an embodiment of the present disclosure may derive recommendation information corresponding to the data set identified in step S520 through an artificial intelligence model. In an embodiment, the artificial intelligence model may be trained based on a data set corresponding to content information included in the input information, and the structure of the artificial intelligence model used in the embodiment according to the present disclosure has been specifically described with reference to FIGS. 3 and 4.

In step S540, the electronic apparatus 120 according to an embodiment of the present disclosure may provide the recommendation information derived in step S530 to the external apparatus 110.

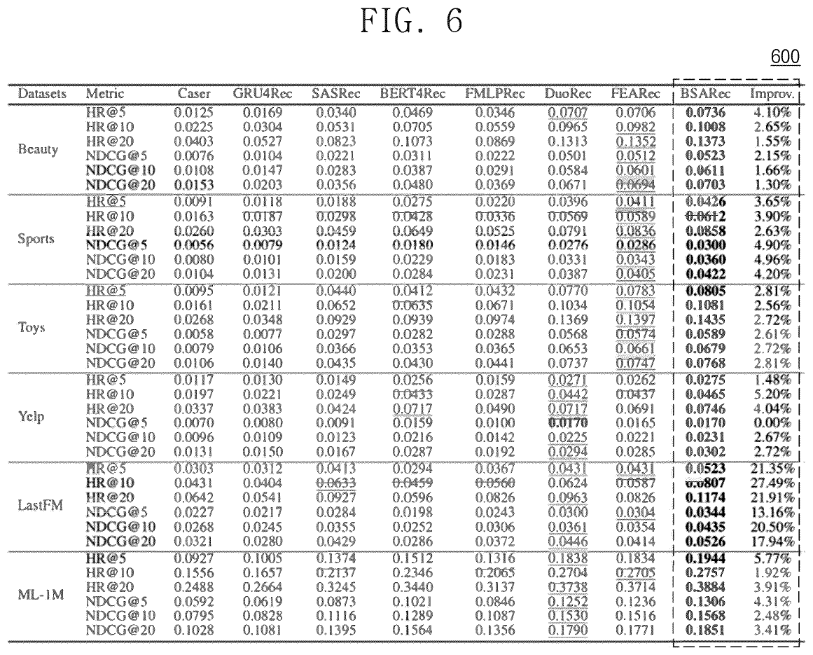

FIG. 6 is a table for showing the performance of the electronic apparatus 120 (see FIG. 1) according to an embodiment of the present disclosure.

FIG. 6 shows the performance of deriving an output value corresponding to the same input in a model utilized in an existing recommendation system and a model built according to an embodiment of the present disclosure. Referring to FIG. 6, it can be seen that the model (BSARec) built for the electronic apparatus 120 according to an embodiment of the present disclosure exhibits improved performance compared to an existing model. In FIG. 6, the degree of performance improvement (Improv.) means the degree of relative improvement compared to the best baseline performance of the existing model.

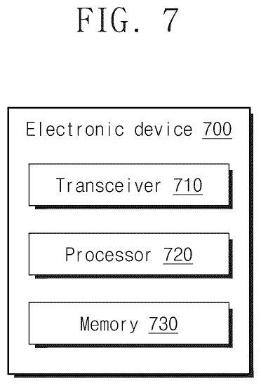

FIG. 7 is a block diagram illustrating an electronic apparatus 700 according to an embodiment of the present disclosure.

The electronic apparatus 700 shown in FIG. 7 may correspond to the electronic apparatus 120 described in FIG. 1. Referring to FIG. 7, the electronic apparatus 700 according to an embodiment of the present disclosure may include a transceiver 710, a processor 720, and a memory 730.

The electronic apparatus 700 may be connected to at least one of an external terminal and an external apparatus via the transceiver 710 to exchange data with the external terminal or the external apparatus.

The processor 720 may perform operations by at least one apparatus (or device), and at least one method described with reference to FIGS. 1 to 6. In addition, the processor 720 may execute a program for performing operations by at least one apparatus (or device), and at least one method described with reference to FIGS. 1 to 6, and may process information and control the electronic apparatus 700 to perform the operations by at least one apparatus (or device) and at least one method described with reference to FIGS. 1 to 6.

The memory 730 may store information for performing operations by at least one apparatus (or device), and at least one method described with reference to FIGS. 1 to 6. In addition, the memory 730 may store the codes of a program executed by the processor 720. In an embodiment, the memory 730 may be a volatile memory or a nonvolatile memory.

On the other hand, the embodiments disclosed in the present disclosure may be implemented in the form of a recording medium storing instructions executable by a computer. The instructions may be stored in the form of program codes, which, when executed by the processor, may generate program modules to perform the operations of the disclosed embodiments. The recording medium may be implemented as a computer-readable recording medium. The computer-readable recording medium may include all types of recording media storing instructions decipherable by a computer. For example, there may be ROM, RAM, magnetic tape, magnetic disk, flash memory, optical data storage devices, or the like. The computer-readable recording medium may be distributed and executed by computer systems connected via a network.

The above-described contents are specific embodiments for practicing the present disclosure. The present disclosure will include not only the embodiments described above, but also embodiments that are simply redesigned or easily modified. In addition, the present disclosure will also include technologies that can be easily modified and practiced using the embodiments described above. Therefore, the scope of the present disclosure should not be limited to the embodiments described above, but should be defined not only by the claims described below but also by equivalents of the claims of the present disclosure.

What is claimed is:

1. A method for providing recommendation information, the method being performed by an electronic apparatus, comprising:
acquiring a data set including a plurality of data having a sequential pattern;
deriving recommendation information corresponding to the data set using a trained artificial intelligence model; and
providing the recommendation information to an external apparatus,
wherein the artificial intelligence model is constructed to include:
a first layer configured to perform embedding on the data set;
a (2-1)-th layer configured to perform self-attention based on a result of the embedding by the first layer; and
a (2-2)-th layer configured to perform data processing to inject an inductive bias based on the result of the embedding by the first layer.

2. The method of claim 1, wherein the artificial intelligence model further includes:
a (3-1)-th layer configured to perform residual connection and normalization of a first result value derived from the (2-1)-th layer;
a (3-2)-th layer configured to perform residual connection and normalization of a second result value derived from the (2-2)-th layer;
a fourth layer configured to perform feed forward based on a third result value derived from the (3-1)-th layer and a fourth result value derived from the (3-2)-th layer;
a fifth layer configured to perform residual connection and normalization based on a fifth result value derived from the fourth layer; and
a sixth layer configured to perform a prediction for the recommendation information based on a sixth result value derived from the fifth layer.

3. The method of claim 2, wherein the fourth layer is configured to perform the feed forward with a first weight assigned to the third result value and a second weight assigned to the fourth result value, and
wherein the first weight and the second weight have a correlation.

4. The method of claim 2, wherein the (2-2)-th layer is configured to:
perform a Fast Fourier Transform (FFT) on the result of the embedding by the first layer;
separate a signal derived by the Fast Fourier Transform into a first signal including a low frequency band equal to or less than a preset threshold frequency and a second signal including a high frequency band greater than the threshold frequency;
perform an inverse transform on each of the first signal and the second signal; and
derive the second result value based on an inversely-transformed first signal and an inversely-transformed second signal.

5. The method of claim 4, wherein the second result value is derived by applying a third weight derived from training of the artificial intelligence model to the inversely-transformed second signal.

6. The method of claim 1, wherein the (2-2)-th layer is configured to perform the data processing based on a Discrete Fourier Transform (DFT) on the result of the embedding by the first layer.

7. The method of claim 1, wherein the data set includes the plurality of data corresponding to one of a user's product purchase history, a user's program viewing history, and a user's search history.

8. The method of claim 1, further comprising:
performing preprocessing, the preprocessing including at least one of a first operation of converting a data format for each of the plurality of data and a second operation of extracting at least a portion of the plurality of data.

9. An electronic apparatus for providing recommendation information, comprising:
a transceiver, a memory configured to store instructions, and a processor,
wherein the processor connected to the transceiver and the memory is configured to:
acquire a data set including a plurality of data having a sequential pattern;
derive recommendation information corresponding to the data set using a trained artificial intelligence model; and
provide the recommendation information to an external apparatus,
wherein the artificial intelligence model is constructed to include:
a first layer configured to perform embedding on the data set;
a (2-1)-th layer configured to perform self-attention based on a result of the embedding by the first layer; and
a (2-2)-th layer configured to perform data processing to inject an inductive bias based on the result of the embedding by the first layer.

10. A computer program stored on a computer-readable storage medium for executing a method of providing recommendation information in conjunction with hardware,
wherein the method of providing the recommendation information includes
acquiring a data set including a plurality of data having a sequential pattern;
deriving recommendation information corresponding to the data set using a trained artificial intelligence model; and
providing the recommendation information to an external apparatus,
wherein the artificial intelligence model is constructed to include:
a first layer configured to perform embedding on the data set;
a (2-1)-th layer configured to perform self-attention based on a result of the embedding by the first layer; and
a (2-2)-th layer configured to perform data processing to inject an inductive bias based on the result of the embedding by the first layer.
